(19) United States
(12) Patent Application Publication
(10) Pub. No.: US 2023/0399246 A1
(43) Pub. Date: Dec. 14, 2023

(54) SYSTEM AND METHOD FOR ENHANCING THE CAPACITY OF AN ADSORPTIVE MEDIA TO REMOVE PER- AND POLYFLUOROALKYL SUBSTANCES (PFAS) FROM A FLOW OF LIQUID CONTAMINATED WITH PFAS AND AT LEAST ONE PRECURSOR

(71) Applicant: Emerging Compounds Treatment Technologies, Inc., North Little Rock, AR (US)

(72) Inventors: Michael G. Nickelsen, Fuquay-Varina, NC (US); Steven E. Woodard, Cumberland, ME (US); John C. Berry, Mooresville, NC (US)

(21) Appl. No.: 18/332,399

(22) Filed: Jun. 9, 2023

Related U.S. Application Data
(60) Provisional application No. 63/351,584, filed on Jun. 13, 2022.

(51) Int. Cl. C02F 1/78; C02F 1/28

(52) U.S. Cl. CPC C02F 1/78; C02F 1/281; C02F 1/285; C02F 2101/36

(57) ABSTRACT

A system for pretreating a flow of a liquid contaminated with per- and polyfluoroalkyl substances (PFAS) and at least one precursor. The system includes a pre-oxidation subsystem configured to receive the flow of liquid contaminated with PFAS and at least one precursor and configured to convert a majority of at least one precursor into PFAS to produce a flow of liquid having the PFAS and the at least one precursor converted to PFAS therein. At least one vessel including an adsorptive media therein is configured to receive the flow of liquid having the PFAS and the at least one precursor converted to PFAS, the adsorptive media configured to remove a majority of the PFAS and a majority of the at least one precursor converted to PFAS and produce a flow of treated liquid having the majority of the PFAS and the majority of the at least one precursor converted to PFAS removed.

### RELATED APPLICATIONS

This application claims benefit of and priority to U.S. Provisional Application Ser. No. 63/351,584 filed Jun. 13, 2022, under 35 U.S.C. §§ 119, 120, 363, 365, and 37 C.F.R. § 1.55 and 1.78, which is incorporated herein by this reference.

### FIELD OF THE INVENTION

This invention relates to a system and method for enhancing the capacity of an adsorptive media to remove per- and polyfluoroalkyl substances (PFAS) from a flow of liquid contaminated with PFAS and at least one precursor.

### BACKGROUND OF THE INVENTION

Precursors are compounds which may transform into PFAS through biological, chemical, and/or environmental processes. Examples of precursors may include, inter alia, 6:2 fluorotelomer sulfonate (6:2FTS), 8:2 Fluorotelomer sulfonic acid (8:2 FTS), perfluorooctanesulfonamide (FOSA), perfluorooctane sulfonamidoacetic acid (FOSAA), and the like. See Zhang et al., Biotransformation of Perfluoroalkyl Acid Precursors From Various Environmental Systems: Advances and Perspectives, Environmental Pollution, 272, p.115908 (2021), Liu, J., Avendario, S. M., Microbial Degradation of Polyfluoroalkyl Chemicals in the Environment: A Review, Environment international, 61, pp. 98-114 (2013), Nilsson et al., Biotransformation of Fluorotelomer Compound to Perfluorocarboxylates in Humans, Environment international, 51, pp. 8-12. (2013), and Houtz, E. F, Sedlak, D. L., Oxidative Conversion as a Means of Detecting Precursors to Perfluoroalkyl Acids in Urban Runoff, Environmental science & technology, 46(17), pp. 9342-9349 (2012), all incorporated by reference herein.

Some liquids contaminated with PFAS and precursors can be challenging to treat because conventional PFAS removal systems which use an adsorptive media, such as anion exchange resin, granular activated carbon (GAC), polymeric resins, or similar type resins often fail to remove the precursors because the precursors may not bind well to the adsorptive media. Additionally, the precursors can be transformed into PFAS at any point in the treatment process, even after the treatment process is complete. This may reduce the capacity of an adsorptive media to remove PFAS from a flow of liquid contaminated with PFAS and precursors which may result in the treated water being contaminated with PFAS.

Thus, there is a need for a system and method that removes PFAS and converts at least one precursor to PFAS to effectively remove the PFAS and the at least one precursor converted to PFAS and which also increases the capacity of an adsorptive media to remove PFAS and at least one precursor.

### SUMMARY OF THE INVENTION

In one aspect, a system for pretreating a flow of a liquid contaminated with per- and polyfluoroalkyl substances (PFAS) and at least one precursor is featured. The system includes a pre-oxidation subsystem configured to receive the flow of liquid contaminated with PFAS and at least one precursor and configured to convert a majority of at least one precursor into PFAS to produce a flow of liquid having the PFAS and the at least one precursor converted to PFAS therein. At least one vessel including an adsorptive media therein is configured to receive the flow of liquid having the PFAS and the at least one precursor converted to PFAS, the adsorptive media configured remove a majority of the PFAS and a majority of the at least one precursor converted to PFAS and produce a flow of treated liquid having the majority of the PFAS and the majority of the at least one precursor converted to PFAS removed.

In one embodiment, the pre-oxidation subsystem may be configured to introduce at least one of: one or more oxidizing agents, UV light, and/or heat into the flow of liquid contaminated with PFAS and at least one precursor to convert the at least one precursor into PFAS. The one or more oxidizing agents may include ozone, oxygen, persulfate, and/or hydrogen peroxide. The system may include one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The pre-oxidation subsystem may include an ozone generator, an ozone injector and a contact tank. The pre-oxidation subsystem may include an ozone generator, a venturi injector and a contact tank. The adsorptive media may include at least one of: an anion exchange resin, carbonaceous resin, granular activated carbon (GAC), or polymeric resin. The at least one vessel may include a plurality of vessels configured in series.

In another aspect, a system for pretreating a flow of a liquid contaminated with per- and polyfluoroalkyl substances (PFAS), at least one precursor, and/or other organic compounds is featured. The system includes a pre-oxidation subsystem configured to receive the flow of liquid contaminated with PFAS, at least one precursor, and/or other organic compounds and configured to convert a majority of at least one precursor into PFAS and remove at least one other organic compound to produce a flow of liquid having the PFAS and the at least one precursor converted to PFAS therein. At least one vessel including an adsorptive media therein is configured to receive the flow of liquid having the PFAS and the at least one precursor converted to PFAS, the adsorptive media configured remove a majority of the PFAS and a majority of the at least one precursor converted to PFAS and produce a flow of treated liquid having the majority of the PFAS and the majority of the at least one precursor converted to PFAS removed.

In one embodiment, the pre-oxidation subsystem may be configured to introduce at least one of: one or more oxidizing agents, UV light, and/or heat into the flow of liquid contaminated with PFAS, at least one precursor, and/or other organic compounds to convert the at least one precursor into PFAS. One or more oxidizing agents may include ozone, oxygen, persulfate, and/or hydrogen peroxide. The system may include one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The pre-oxidation subsystem may include an ozone generator, an ozone injector and a contact tank. The pre-oxidation subsystem may include an ozone generator, a venturi injector and a contact tank. The adsorptive media may include at least one of: an anion exchange resin, carbonaceous resin, granular activated carbon (GAC), or polymeric resin. The at least one vessel may include a plurality of vessels configured in series.

In another aspect, a system for enhancing the capacity of an adsorptive media to remove PFAS from a flow of liquid contaminated with PFAS and at least one precursor is featured. The system includes a pre-oxidation subsystem configured to receive the flow of liquid contaminated with PFAS and at least one precursor, the pre-oxidation subsystem configured to enhance the capacity of an adsorptive media to remove PFAS from the flow of liquid contaminated with PFAS and a least one precursor and produce a treated flow of liquid having a majority of the PFAS removed.

In one embodiment, the pre-oxidation subsystem may be configured to introduce at least one of: one or more oxidizing agents, UV light, and/or heat into the flow of liquid contaminated with PFAS and at least one precursor to convert the at least one precursor into PFAS. The one or more oxidizing agents may include ozone, oxygen, persulfate, and/or hydrogen peroxide. The system may include one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The pre-oxidation subsystem may include an ozone generator, an ozone injector and a contact tank. The pre-oxidation subsystem may include an ozone generator, a venturi injector and a contact tank. The adsorptive media may include at least one of: an anion exchange resin, a carbonaceous resin, granular activated carbon (GAC), or polymeric resin. The adsorptive media may be housed in at least one vessel. The at least one vessel may include a plurality of vessels configured in series.

In another aspect, a system for enhancing the capacity of an adsorptive media to remove PFAS from a flow of liquid contaminated with PFAS, at least one precursor, and other organic compound is featured. The system includes a pre-oxidation subsystem configured to receive the flow of liquid contaminated with PFAS, at least one precursor, at least one precursor, and other organic compounds, the pre-oxidation subsystem configured to enhance the capacity of an adsorptive media to remove PFAS from the flow of liquid contaminated with PFAS, at least one precursor, and other organic compounds and produce a treated flow of liquid having a majority of the PFAS removed.

In one embodiment, the pre-oxidation subsystem may be configured to introduce at least one of: one or more oxidizing agents, UV light, and/or heat into the flow of liquid contaminated with PFAS, at least one precursor, and other organic compounds to convert the at least one precursor into PFAS and remove at least one of the other organic compounds. The one or more oxidizing agents may include ozone, oxygen, persulfate, and/or hydrogen peroxide. The system may include one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The pre-oxidation subsystem may include an ozone generator, an ozone injector and a contact tank. The pre-oxidation subsystem may include an ozone generator, a venturi injector and a contact tank. The adsorptive media may include at least one of: an anion exchange resin, a carbonaceous resin, granular activated carbon (GAC), or polymeric resin. The adsorptive media may be housed in at least one vessel. The at least one vessel may include a plurality of vessels configured in series.

In another aspect, a method for pretreating a flow of a liquid contaminated with per- and polyfluoroalkyl substances (PFAS) and at least one precursor is featured. The method includes receiving the flow of liquid contaminated with PFAS and at least one precursor, subjecting the flow of liquid contaminated with PFAS and at least one precursor to a pre-oxidation process converts a majority of at least one precursor into PFAS to produce a flow of liquid having the PFAS and the at least one precursor converted to PFAS therein, receiving the flow of liquid having the PFAS and the at least one precursor is converted to PFAS therein, removing a majority of the PFAS and a majority of the at least one precursor is converted to PFAS with an adsorptive media, and producing a flow of treated liquid having the majority of the PFAS and the majority of the at least one precursor converted to PFAS is removed.

In one embodiment, the pre-oxidation process may be introduced at least one of: one or more oxidizing agents, UV light, and/or heat into the flow of liquid contaminated with PFAS and at least one precursor to convert the at least one precursor into PFAS. The one or more oxidizing agents may include ozone, oxygen, persulfate, and/or hydrogen peroxide. The method may include performing one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The adsorptive media may include at least one of: an anion exchange resin, carbonaceous resin, granular activated carbon (GAC), or polymeric resin.

In another aspect, a method for pretreating a flow of a liquid contaminated with per- and polyfluoroalkyl substances (PFAS), at least one precursor, and/or other organic compounds is featured. The method includes receiving the flow of liquid contaminated with PFAS, at least one precursor, and/or other organic compounds, subjecting the flow of liquid contaminated with PFAS, at least one precursor, and/or other organic compounds to a pre-oxidation process to converts a majority of at least one precursor into PFAS and remove at least one other organic compound to produce a flow of liquid having the PFAS and the at least one precursor converted to PFAS therein, receiving the flow of liquid having the PFAS and the at least one precursor is converted to PFAS therein, removing a majority of the PFAS and a majority of the at least one precursor is converted to PFAS with an adsorptive media, and producing a flow of treated liquid having the majority of the PFAS and the majority of the at least one precursor converted to PFAS is removed.

In one embodiment, the pre-oxidation process may be introduced at least one of: one or more oxidizing agents, UV light, and/or heat into the flow of liquid contaminated with PFAS, at least one precursor, and/or other organic compounds to convert the at least one precursor into PFAS. The one or more oxidizing agents may include ozone, oxygen, persulfate, and/or hydrogen peroxide. The method may include one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The adsorptive media may include at least one of: an anion exchange resin, carbonaceous resin, granular activated carbon (GAC), or polymeric resin.

In another aspect, a method for enhancing the capacity of an adsorptive media to remove PFAS from a flow of liquid contaminated with PFAS and at least one precursor is featured. The method includes receiving the flow of liquid contaminated with PFAS and at least one precursor, and subjecting the flow of liquid contaminated with PFAS and at least one precursor to a pre-oxidation process to enhance the capacity of an adsorptive media to remove PFAS from the flow of liquid contaminated with PFAS and a least one precursor and produce a treated flow of liquid having a majority of the PFAS removed.

In one embodiment, the pre-oxidation process may be introduced at least one of: one or more oxidizing agents, UV light, and/or heat into the flow of liquid contaminated with PFAS and at least one precursor to convert the at least one precursor into PFAS. The one or more oxidizing agents may include ozone, oxygen, persulfate, and/or hydrogen peroxide. The method may include one or more advanced oxidation processes comprising at least one hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The adsorptive media may include at least one of: an anion exchange resin, a carbonaceous resin, granular activated carbon (GAC), or polymeric resin.

In another aspect, a method for enhancing the capacity of an adsorptive media to remove PFAS from a flow of liquid contaminated with PFAS, at least one precursor, and/or other organic compounds is featured. The method includes receiving the flow of liquid contaminated with PFAS, at least one precursor, and other organic compounds, and subjecting the flow of liquid contaminated with PFAS, at least one precursor, and other organic compounds to a pre-oxidation process to enhance the capacity of an adsorptive media to remove PFAS from the flow of liquid contaminated with PFAS, a least one precursor, and other organic compounds and produce a treated flow of liquid having a majority of the PFAS removed.

In one embodiment, the pre-oxidation process may be introduced at least one of: one or more oxidizing agents, UV light, and/or heat into the flow of liquid contaminated with PFAS, at least one precursor, and/or other organic compounds to convert the at least one precursor into PFAS and remove at least one of the other organic compounds. The one or more oxidizing agents may include ozone, oxygen, persulfate, and/or hydrogen peroxide. The method may include one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The adsorptive media may include at least one of: an anion exchange resin, a carbonaceous resin, granular activated carbon (GAC), or polymeric resin.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block flow diagram showing the primary components of one example of system for enhancing the capacity of an adsorptive media to remove PFAS from a flow of liquid contaminated with PFAS and at least one precursor;

FIG. 2 is a schematic block flow diagram showing in further detail one example of the pre-oxidation subsystem shown in FIG. 1;

FIG. 3 is a schematic block flow diagram showing in further detail another example of the pre-oxidation subsystem shown in FIG. 1;

FIG. 4 is a schematic block flow diagram showing in further detail of yet another example of the pre-oxidation subsystem shown in FIG. 1;

FIG. 5 is a schematic block flow diagram showing one example of the system shown in one or more of FIGS. 1-4 including a plurality of vessels with adsorptive media therein connected in series;

FIG. 6 is a flow chart depicting the primary steps of one example of the method for enhancing the capacity of an adsorptive media to remove PFAS from a flow of liquid contaminated with PFAS and at least one precursor;

FIG. 7 is a flow chart depicting the primary steps of one example of the method for enhancing the capacity of an adsorptive media to remove PFAS from a flow of liquid contaminated with PFAS, and at least one precursor, and/or other organic compounds;

FIG. 8 is a flow chart depicting the primary steps of another example of the method for enhancing the capacity of an adsorptive media to remove PFAS from a flow of liquid contaminated with PFAS and at least one precursor; and

FIG. 9 is a flow chart depicting the primary steps of another example of the method for enhancing the capacity of an adsorptive media to remove PFAS from a flow of liquid contaminated with PFAS, and at least one precursor, and/or other organic compounds.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

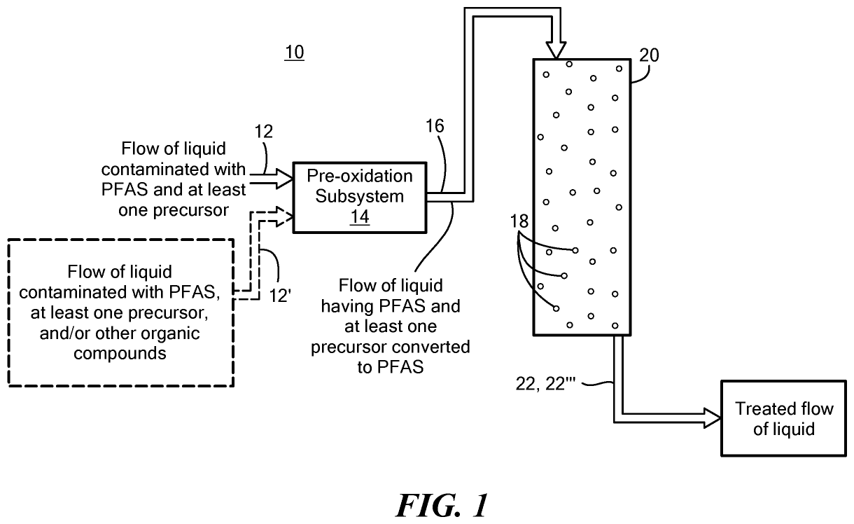

There is shown in FIG. 1 one embodiment of system 10 and the method thereof for pretreating flow 12 of liquid contaminated with PFAS and at least one precursor, e.g., one or more of the precursors discussed in the Background section above or similar type precursor. System 10 includes pre-oxidation subsystem 14 which receives flow 12 and converts a majority of at least one precursor into PFAS, as discussed in detail below, and produces flow 16 of liquid having the PFAS and the at least one precursor converted to PFAS therein. As defined herein, a majority is greater than about 50 percent.

System 10 also includes an adsorptive media, e.g., an anion exchange resin, granular activated carbon (GAC), polymeric resin, a carbonaceous resin, or similar type adsorptive media, exemplarily indicated at 18, housed in at least one vessel 20. At least one vessel 20 with adsorptive media 18 therein is in fluidic communication with pre-oxidation subsystem 14 as shown and receives flow 16. Adsorptive media 18 removes a majority of the PFAS and a majority of the at least one precursor converted to PFAS by sorbing the majority of the PFAS and the majority of the at least one precursor converted to PFAS in flow 16 and produces flow 22 of treated liquid having a majority of the PFAS and the majority of the at least one precursor converted to PFAS removed.

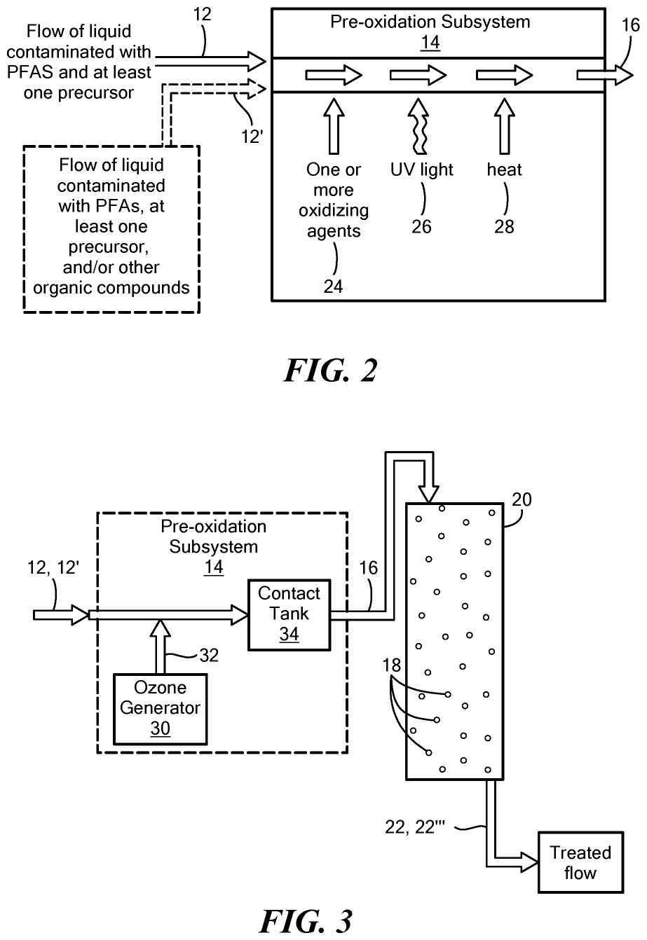

In one example, pre-oxidation subsystem 14, shown in greater detail in FIG. 2, preferably introduces at least one of, a combination of, or all of, one or more oxidizing agents 24, UV light 26, and/or heat 28 into flow 12 of liquid contaminated with PFAS and at least one precursor to preferably convert a majority of the at least one precursor into PFAS.

In one design, the one or more oxidizing agents may include ozone, oxygen, persulfate and/or hydrogen peroxide. System 10 also may include one or more advanced oxidation processes. In one example, the one or more advanced oxidation processes may include at least one of hydrogen peroxide and UV light; hydrogen peroxide and ozone; ozone and UV light; hydrogen peroxide, ozone and UV light; hydrogen peroxide and ferrous sulfate (FeSO₄), also known as Fenton's reagent; titanium dioxide (TiO₂) and UV light; or heat activated persulfate.

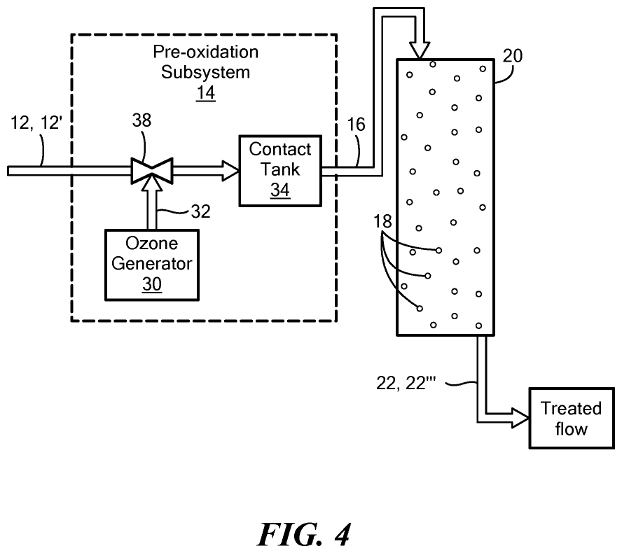

In one design pre-oxidation subsystem 14, FIGS. 1 and 2, may include ozone generator 30, FIG. 3, ozone injector 32 and contact tank 34. In another design pre-oxidation subsystem 14 may include ozone generator 30, FIG. 4, venturi inductor 38, and contact tank 34.

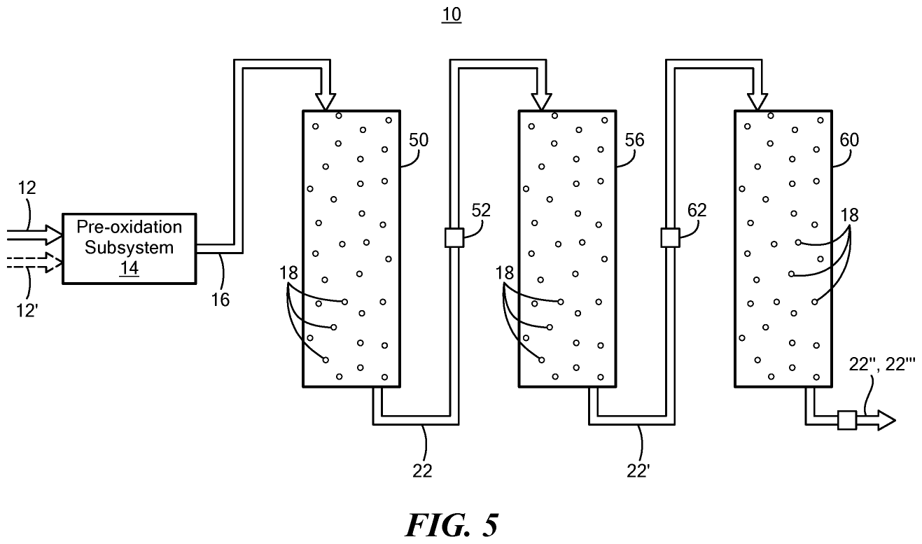

In one example, system 10 and the method thereof may include a plurality of vessels each with an adsorptive media 18 therein connected in series, e.g., as shown in FIG. 5. In this example, pre-oxidation subsystem 14 as discussed above with reference to one or more of FIGS. 1-4, receives flow 12 and produces flow 16 of liquid having PFAS and the at least one precursor converted to PFAS therein. Flow 16 is then preferably directed to vessel 50 having adsorptive media 18 therein which removes a majority of the PFAS and a majority of the at least one precursor converted to PFAS similar as discussed above and produces treated flow 22 of liquid having the majority of the PFAS and a majority of the at least one precursor converted to PFAS removed.

In this example, system 10 preferably includes tap 52 which preferably detects a predetermined breakthrough concentration level of PFAS or the at least one precursor converted to PFAS that may breakthrough anion exchange vessel 50 with adsorptive media 18 therein. In this example, system 10 also preferably includes vessel 56 having adsorptive media 18 which receives flow 22 and removes carryover PFAS and/or carryover at least one precursor converted to PFAS in flow 22 that may breakthrough anion exchange vessel 50 with adsorptive media 18 therein and outputs treated flow 22′ of liquid having the majority of the PFAS and a majority of the at least one precursor converted to PFAS removed. System 10 also preferably includes vessel 60 having adsorptive media 18 therein connected in series with vessel 56 as shown. Adsorptive media 18 in vessel 60 preferably removes carryover PFAS and/or carryover at least one precursor converted to PFAS that may break through vessel 56. Similar as discussed above, tap 62 preferably detects a predetermined breakthrough concentration level of carryover PFAS and/or carryover at least one precursor converted to PFAS converted to PFAS that may breakthrough anion exchange vessel 50 with adsorptive media 18 therein. Vessel 60 with adsorptive media 18 therein preferably outputs treated flow 22″ of liquid having the majority of the PFAS and a majority of the at least one precursor converted to PFAS removed.

One or more of vessels 50, 56 and/or 60 may be configured as a lead vessel and another of one or more of vessels 50, 56 and/or 60 may be configured as a lag vessel so that adsorptive media 18 in one of vessels 50, 56, or 60 can be regenerated onsite when adsorptive media is configured as an anion exchange resin, or replaced when adsorptive media is polymeric, carbonaceous resin or GAC. Details of examples of switching between lead and lag vessels is disclosed in commonly owned U.S. Pat. No. 10,695,709, incorporated by reference herein, and known by those skilled in the art.

In other examples, organic compounds other than precursors, e.g., humic acid, fulvic acid, tannic acid, and the like, as measured by a total organic carbon (TOC) or dissolved organic carbon (DOC) methods, defined herein as “other organic compounds”, may adversely affect the capacity of adsorptive media 18 to remove PFAS and/or at least one precursor.

To address this problem, system 10 and the method thereof includes pre-oxidation subsystem 14, as discussed above with reference to one or more of FIGS. 1-5, which receives flow 12′ of liquid contaminated with PFAS, at least one precursor and/or other organic compounds and converts a majority of the at least one precursor into PFAS and removes at least one other organic compound to produce a flow 16 of liquid having the PFAS and the at least one precursor converted to PFAS therein. Similar as discussed above, adsorptive media 18 housed in at least one vessel, e.g., vessel 20, FIGS. 1, 3, and 4, or any of vessels 50, 56 or 60, FIG. 5, receives flow 16 removes a majority of the PFAS and a majority of the at least one precursor converted to PFAS and produces flow 22 of treated liquid having a majority of the PFAS and a majority of the at least one precursor converted to PFAS removed.

In another example, system 10 and the method thereof, shown in one or more of FIGS. 1-5, preferably includes pre-oxidation subsystem 14 which receives flow 12 of liquid contaminated with PFAS and at least one precursor. In this example, pre-oxidation subsystem 14 enhances the capacity of adsorptive media 18 to remove PFAS from flow 12 and produces treated flow 22′″ of liquid having a majority of the PFAS removed.

In yet another example, system 10 and the method thereof, shown in one or more of FIGS. 1-5, preferably includes pre-oxidation subsystem 14 which receives flow 12′ of liquid contaminated with PFAS, at least one precursor, and/or other organic compounds. In this example, pre-oxidation subsystem 14 enhances the capacity of adsorptive media 18 to remove PFAS from flow 12′ of liquid contaminated with PFAS, at least one precursor, and/or other organic compounds and produces a treated flow 22′″ of liquid having a majority of the PFAS removed.

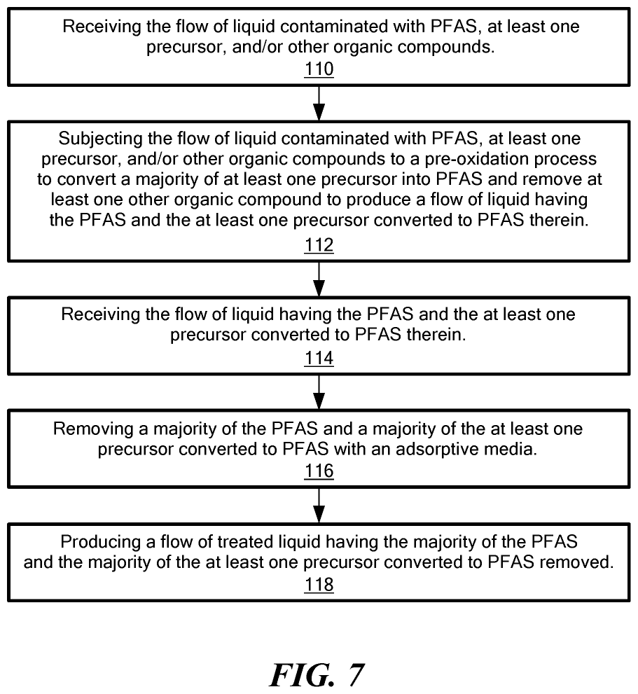

One example of the method for pretreating a flow of a liquid contaminated with per- and polyfluoroalkyl substances (PFAS) and at least one precursor includes receiving the flow of liquid contaminated with PFAS and at least one precursor, step 100, FIG. 7, subjecting the flow of liquid contaminated with PFAS and at least one precursor to a pre-oxidation process to convert a majority of at least one precursor into PFAS to produce a flow of liquid having the PFAS and the at least one precursor converted to PFAS therein, step 102, receiving the flow of liquid having the PFAS and the at least one precursor converted to PFAS therein, step 104, removing a majority of the PFAS and a majority of the at least one precursor converted to PFAS with an adsorptive media, step 106, and producing a flow of treated liquid having the majority of the PFAS and the majority of the at least one precursor converted to PFAS removed, step 108.

One example of the method for pretreating a flow of a liquid contaminated with per- and polyfluoroalkyl substances (PFAS), at least one precursor, and/or other organic compound includes receiving the flow of liquid contaminated with PFAS, at least one precursor, and/or other organic compounds, step 110, FIG. 7, subjecting the flow of liquid contaminated with PFAS, at least one precursor, and/or other organic compounds to a pre-oxidation process to convert a majority of at least one precursor into PFAS and remove at least one other organic compound to produce a flow of liquid having the PFAS and the at least one precursor converted to PFAS therein, step 112, receiving the flow of liquid having the PFAS and the at least one precursor converted to PFAS therein, step 114, removing a majority of the PFAS and a majority of the at least one precursor converted to PFAS with an adsorptive media, step 116, and producing a flow of treated liquid having the majority of the PFAS and the majority of the at least one precursor converted to PFAS removed, step 118.

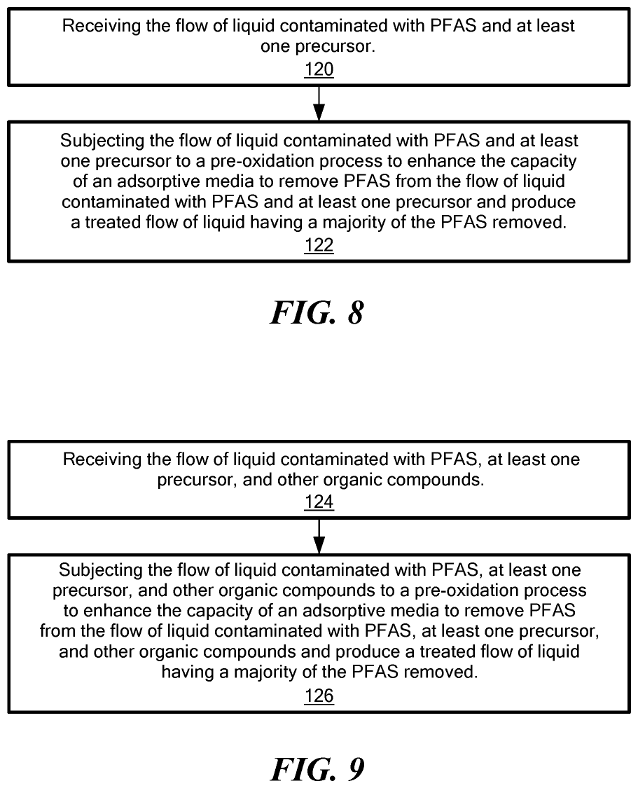

One example of the method for enhancing the capacity of an adsorptive media to remove PFAS from a flow of liquid contaminated with PFAS and at least one precursor includes receiving the flow of liquid contaminated with PFAS and at least one precursor, step 120, FIG. 8, and subjecting the flow of liquid contaminated with PFAS and at least one precursor to a pre-oxidation process to enhance the capacity of an adsorptive media to remove PFAS from the flow of liquid contaminated with PFAS and a least one precursor and produce a treated flow of liquid having a majority of the PFAS removed, step 122.

Another example of the method for enhancing the capacity of an adsorptive media to remove PFAS from a flow of liquid contaminated with PFAS, at least one precursor, and other organic compound includes receiving the flow of liquid contaminated with PFAS, at least one precursor, and other organic compounds, step 124, FIG. 9, and subjecting the flow of liquid contaminated with PFAS, at least one precursor, and other organic compounds to a pre-oxidation process to enhance the capacity of an adsorptive media to remove PFAS from the flow of liquid contaminated with PFAS, a least one precursor, and other organic compounds and produce a treated flow of liquid having a majority of the PFAS removed, step 126.

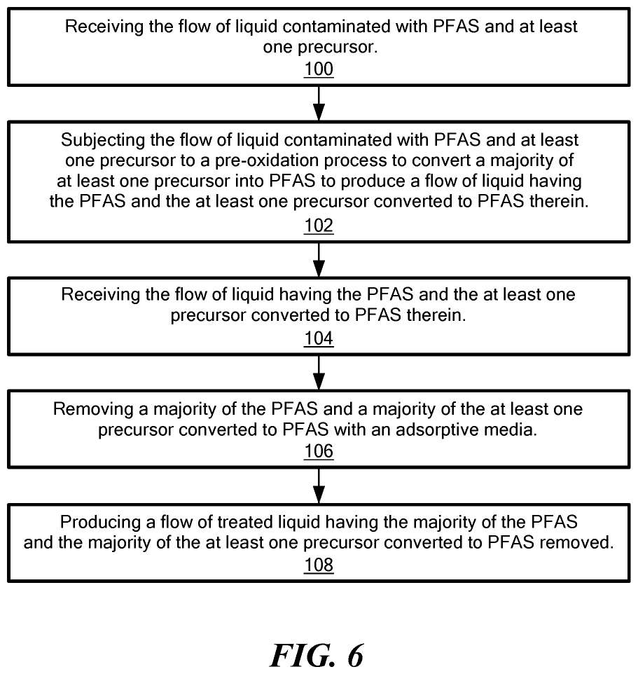

In the examples discussed above with reference to FIGS. 6-9, the pre-oxidation process may introduce at least one of: one or more oxidizing agents, UV light, and/or heat into the flow of liquid contaminated with PFAS and at least one precursor or into the flow of liquid contaminated with PFAS, at least one precursor, and/or other organic compounds to convert the at least one precursor into PFAS. The one or more oxidizing agents may include ozone, oxygen, persulfate, and/or hydrogen peroxide. The method may include performing one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate. The adsorptive media may include at least one of: an anion exchange resin, carbonaceous resin, granular activated carbon (GAC), or polymeric resin.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A system for pretreating a flow of a liquid contaminated with per- and polyfluoroalkyl substances (PFAS) and at least one precursor, the system comprising:
a pre-oxidation subsystem configured to receive the flow of liquid contaminated with PFAS and at least one precursor and configured to convert a majority of at least one precursor into PFAS to produce a flow of liquid having the PFAS and the at least one precursor converted to PFAS therein; and
at least one vessel including an adsorptive media therein configured to receive the flow of liquid having the PFAS and the at least one precursor converted to PFAS, the adsorptive media configured remove a majority of the PFAS and a majority of the at least one precursor converted to PFAS and produce a flow of treated liquid having the majority of the PFAS and the majority of the at least one precursor converted to PFAS removed.

2. The system of claim 1 in which the pre-oxidation subsystem is configured to introduce at least one of: one or more oxidizing agents, UV light, and/or heat into the flow of liquid contaminated with PFAS and at least one precursor to convert the at least one precursor into PFAS.

3. The system of claim 2 in which the one or more oxidizing agents include ozone, oxygen, persulfate, and/or hydrogen peroxide.

4. The system of claim 2 further including one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

5. The system of claim 3 in which the pre-oxidation subsystem includes an ozone generator, an ozone injector and a contact tank.

6. The system of claim 3 in which the pre-oxidation subsystem includes an ozone generator, a venturi injector and a contact tank.

7. The system of claim 1 in which the adsorptive media includes at least one of: an anion exchange resin, carbonaceous resin, granular activated carbon (GAC), or polymeric resin.

8. The system of claim 1 in which the at least one vessel includes a plurality of vessels configured in series.

9. A system for pretreating a flow of a liquid contaminated with per- and polyfluoroalkyl substances (PFAS), at least one precursor, and/or other organic compounds, the system comprising:
a pre-oxidation subsystem configured to receive the flow of liquid contaminated with PFAS, at least one precursor, and/or other organic compounds and configured to convert a majority of at least one precursor into PFAS and remove at least one other organic compound to produce a flow of liquid having the PFAS and the at least one precursor converted to PFAS therein; and
at least one vessel including an adsorptive media therein configured to receive the flow of liquid having the PFAS and the at least one precursor converted to PFAS, the adsorptive media configured remove a majority of the PFAS and a majority of the at least one precursor converted to PFAS and produce a flow of treated liquid having the majority of the PFAS and the majority of the at least one precursor converted to PFAS removed.

10. The system of claim 9 in which the pre-oxidation subsystem is configured to introduce at least one of: one or more oxidizing agents, UV light, and/or heat into the flow of liquid contaminated with PFAS, at least one precursor, and/or other organic compounds to convert the at least one precursor into PFAS.

11. The system of claim 10 in which the one or more oxidizing agents include ozone, oxygen, persulfate, and/or hydrogen peroxide.

12. The system of claim 11 further including one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

13. The system of claim 11 in which the pre-oxidation subsystem includes an ozone generator, an ozone injector and a contact tank.

14. The system of claim 11 in which the pre-oxidation subsystem includes an ozone generator, a venturi injector and a contact tank

15. The system of claim 9 in which the adsorptive media includes at least one of: an anion exchange resin, carbonaceous resin, granular activated carbon (GAC), or polymeric resin.

16. The system of claim 9 in which the at least one vessel includes a plurality of vessels configured in series.

17. A system for enhancing the capacity of an adsorptive media to remove PFAS from a flow of liquid contaminated with PFAS and at least one precursor, the system comprising:
a pre-oxidation subsystem configured to receive the flow of liquid contaminated with PFAS and at least one precursor, the pre-oxidation subsystem configured to enhance the capacity of an adsorptive media to remove PFAS from the flow of liquid contaminated with PFAS and a least one precursor and produce a treated flow of liquid having a majority of the PFAS removed.

18. The system of claim 17 in which the pre-oxidation subsystem is configured to introduce at least one of: one or more oxidizing agents, UV light, and/or heat into the flow of liquid contaminated with PFAS and at least one precursor to convert the at least one precursor into PFAS.

19. The system of claim 18 in which the one or more oxidizing agents include ozone, oxygen, persulfate, and/or hydrogen peroxide.

20. The system of claim 19 further including one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

21. The system of claim 19 in which the pre-oxidation subsystem includes an ozone generator, an ozone injector and a contact tank.

22. The system of claim 19 in which the pre-oxidation subsystem includes an ozone generator, a venturi injector and a contact tank.

23. The system of claim 17 in which the adsorptive media includes at least one of: an anion exchange resin, a carbonaceous resin, granular activated carbon (GAC), or polymeric resin.

24. The system of claim 17 in which the adsorptive media is housed in at least one vessel.

25. The system of claim 24 in which the at least one vessel includes a plurality of vessels configured in series.

26. A system for enhancing the capacity of an adsorptive media to remove PFAS from a flow of liquid contaminated with PFAS, at least one precursor, and other organic compounds, the system comprising:
a pre-oxidation subsystem configured to receive the flow of liquid contaminated with PFAS, at least one precursor, and other organic compounds, the pre-oxidation subsystem configured to enhance the capacity of an adsorptive media to remove PFAS from the flow of liquid contaminated with PFAS, a least one precursor, and other organic compounds and produce a treated flow of liquid having a majority of the PFAS removed.

27. The system of claim 26 in which the pre-oxidation subsystem is configured to introduce at least one of: one or more oxidizing agents, UV light, and/or heat into the flow of liquid contaminated with PFAS, at least one precursor, and other organic compounds to convert the at least one precursor into PFAS and remove at least one of the other organic compounds.

28. The system of claim 27 in which the one or more oxidizing agents include ozone, oxygen, persulfate, and/or hydrogen peroxide.

29. The system of claim 28 further including one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

30. The system of claim 28 in which the pre-oxidation subsystem includes an ozone generator, an ozone injector and a contact tank.

31. The system of claim 28 in which the pre-oxidation subsystem includes an ozone generator, a venturi injector and a contact tank.

32. The system of claim 26 in which the adsorptive media includes at least one of: an anion exchange resin, a carbonaceous resin, granular activated carbon (GAC), or polymeric resin.

33. The system of claim 26 in which the adsorptive media is housed in at least one vessel.

34. The system of claim 33 in which the at least one vessel includes a plurality of vessels configured in series.

35. A method for pretreating a flow of a liquid contaminated with per- and polyfluoroalkyl substances (PFAS) and at least one precursor, the method comprising:
receiving the flow of liquid contaminated with PFAS and at least one precursor;
subjecting the flow of liquid contaminated with PFAS and at least one precursor to a pre-oxidation process to convert a majority of at least one precursor into PFAS to produce a flow of liquid having the PFAS and the at least one precursor converted to PFAS therein;
receiving the flow of liquid having the PFAS and the at least one precursor converted to PFAS therein;
removing a majority of the PFAS and a majority of the at least one precursor converted to PFAS with an adsorptive media; and
producing a flow of treated liquid having the majority of the PFAS and the majority of the at least one precursor converted to PFAS removed.

36. The method of claim 35 in which the pre-oxidation process introduces at least one of: one or more oxidizing agents, UV light, and/or heat into the flow of liquid contaminated with PFAS and at least one precursor to convert the at least one precursor into PFAS.

37. The method of claim 36 in which the one or more oxidizing agents include ozone, oxygen, persulfate, and/or hydrogen peroxide.

38. The method of claim 36 further including performing one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

39. The method of claim 35 in which the adsorptive media includes at least one of: an anion exchange resin, carbonaceous resin, granular activated carbon (GAC), or polymeric resin.

40. A method for pretreating a flow of a liquid contaminated with per- and polyfluoroalkyl substances (PFAS), at least one precursor, and/or other organic compounds, the method comprising:
receiving the flow of liquid contaminated with PFAS, at least one precursor, and/or other organic compounds;
subjecting the flow of liquid contaminated with PFAS, at least one precursor, and/or other organic compounds to a pre-oxidation process to convert a majority of at least one precursor into PFAS and remove at least one other organic compound to produce a flow of liquid having the PFAS and the at least one precursor converted to PFAS therein;
receiving the flow of liquid having the PFAS and the at least one precursor converted to PFAS therein;
removing a majority of the PFAS and a majority of the at least one precursor converted to PFAS with an adsorptive media; and
producing a flow of treated liquid having the majority of the PFAS and the majority of the at least one precursor converted to PFAS removed.

41. The method of claim 40 in which the pre-oxidation process introduces at least one of: one or more oxidizing agents, UV light, and/or heat into the flow of liquid contaminated with PFAS, at least one precursor, and/or other organic compounds to convert the at least one precursor into PFAS.

42. The method of claim 41 in which the one or more oxidizing agents include ozone, oxygen, persulfate, and/or hydrogen peroxide.

43. The method of claim 41 further including one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

44. The method of claim 40 in which the adsorptive media includes at least one of: an anion exchange resin, carbonaceous resin, granular activated carbon (GAC), or polymeric resin.

45. A method for enhancing the capacity of an adsorptive media to remove PFAS from a flow of liquid contaminated with PFAS and at least one precursor, the method comprising:
receiving the flow of liquid contaminated with PFAS and at least one precursor;
subjecting the flow of liquid contaminated with PFAS and at least one precursor to a pre-oxidation process to enhance the capacity of an adsorptive media to remove PFAS from the flow of liquid contaminated with PFAS and a least one precursor and produce a treated flow of liquid having a majority of the PFAS removed.

46. The method of claim 45 in which the pre-oxidation process introduces at least one of: one or more oxidizing agents, UV light, and/or heat into the flow of liquid contaminated with PFAS and at least one precursor to convert the at least one precursor into PFAS.

47. The method of claim 46 in which the one or more oxidizing agents include ozone, oxygen, persulfate, and/or hydrogen peroxide.

48. The method of claim 46 further including one or more advanced oxidation processes comprising at least one hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

49. The method of claim 45 in which the adsorptive media includes at least one of: an anion exchange resin, a carbonaceous resin, granular activated carbon (GAC), or polymeric resin.

50. A method for enhancing the capacity of an adsorptive media to remove PFAS from a flow of liquid contaminated with PFAS, at least one precursor, and/or other organic compounds, the method comprising:
receiving the flow of liquid contaminated with PFAS, at least one precursor, and other organic compounds;
subjecting the flow of liquid contaminated with PFAS, at least one precursor, and other organic compounds to a pre-oxidation process to enhance the capacity of an adsorptive media to remove PFAS from the flow of liquid contaminated with PFAS, a least one precursor, and other organic compounds and produce a treated flow of liquid having a majority of the PFAS removed.

51. The method of claim 50 in which the pre-oxidation process introduces at least one of: one or more oxidizing agents, UV light, and/or heat into the flow of liquid contaminated with PFAS, at least one precursor, and/or other organic compounds to convert the at least one precursor into PFAS and remove at least one of the other organic compounds.

52. The method of claim 51 in which the one or more oxidizing agents include ozone, oxygen, persulfate, and/or hydrogen peroxide.

53. The method of claim 51 further including one or more advanced oxidation processes comprising at least one of: hydrogen peroxide and UV light; hydrogen peroxide and ozone; ozone and UV light; hydrogen peroxide, ozone and UV light; hydrogen peroxide and ferrous sulfate; titanium dioxide and UV light; or heat activated persulfate.

54. The method of claim 50 in which the adsorptive media includes at least one of: an anion exchange resin, a carbonaceous resin, granular activated carbon (GAC), or polymeric resin.
